(19) United States
(12) Patent Application Publication
(10) Pub. No.: US 2024/0413730 A1
(43) Pub. Date: Dec. 12, 2024

(54) ELECTROLYSIS-FREE MAGNETOHYDRODYNAMIC PUMPING OF SALT WATER

(71) Applicant: The Government of the United States of America, as represented by the Secretary of the Navy, Arlington, VA (US)

(72) Inventors: Zachary G. Neale, Alexandria, VA (US); Jeffrey W. Long, Alexandria, VA (US); Ryan H. DeBlock, Alexandria, VA (US); Debra R. Rolison, Arlington, VA (US)

(73) Assignee: The Government of the United States of America, as represented by the Secretary of the Navy, Arlington, VA (US)

(21) Appl. No.: 18/737,599

(22) Filed: Jun. 7, 2024

Related U.S. Application Data
(60) Provisional application No. 63/507,116, filed on Jun. 9, 2023.

(51) Int. Cl. H02K 44/06

(52) U.S. Cl. CPC H02K 44/06

(57) ABSTRACT

An apparatus having a flow cell having a first port and a second port allowing for flow of an aqueous salt solution in a flow direction from the first port to the second port or from the second port to the first port; a first electrode positioned to be in contact with the aqueous salt solution; a second electrode positioned to be in contact with the aqueous salt solution and in an electrode direction from the first electrode that is orthogonal to the flow direction; and a magnetic field generator that generates a magnetic field in a magnetic direction that is orthogonal to the flow direction and orthogonal to the electrode direction. The electrodes may be charge-storage electrodes.

### REFERENCE TO RELATED APPLICATIONS

This application claims the benefit of U.S. Provisional Application No. 63/507,116, filed on Jun. 9, 2023. The provisional application and all other publications and patent documents referred to throughout this nonprovisional application are incorporated herein by reference.

### TECHNICAL FIELD

The present disclosure is generally related to magnetohydrodynamic (MHD) flow cells.

### DESCRIPTION OF THE RELATED ART

Magnetohydrodynamic pumping of salt water has conventionally relied on generating thrust by using electrodes that electrolyze water to produce necessary current across a perpendicular magnetic field. Electrolysis unavoidably produces gases that may block electrochemically active surface area, disrupt flow dynamics, and create safety hazards for operation (such as generation of toxic chlorine gas and/or explosive oxygen/hydrogen mixtures). Intermittent MHD pumping can be performed at voltages below the thermodynamic value (1.23 V) for water electrolysis by using battery-like and pseudocapacitive-like electrodes that in salt water undergo reversible faradaic reactions—sodium-ion intercalation in manganese oxide (MnO₂) and chloride-ion capture by silver (Ag). The lower voltage of such cells leads to improved pumping efficiency while also avoiding the issues noted above for gas formation. Fabricating the faradaic electrodes in porous form factors further enhances the currents that they can achieve (Liu et al., Porous electrode improving energy efficiency under electrode-normal magnetic field in water electrolysis. Int. J. Hydrogen Energy 2019, 44, 22780). When operating faradaic cells, the polarity of the cell must be periodically reversed when the capacity limits of the electrodes are reached. Continuous fluid flow is sustained by synchronizing direction of the applied magnetic field with reversal of cell polarity.

### SUMMARY OF THE INVENTION

Disclosed herein is an apparatus comprising: a flow cell having a first port and a second port allowing for flow of an aqueous salt solution in a flow direction from the first port to the second port or from the second port to the first port; a first charge storage electrode positioned to be in contact with the aqueous salt solution; a second charge storage electrode positioned to be in contact with the aqueous salt solution and in an electrode direction from the first charge storage electrode that is orthogonal to the flow direction; and a magnetic field generator that generates a magnetic field in a magnetic direction that is orthogonal to the flow direction and orthogonal to the electrode direction.

### BRIEF DESCRIPTION OF DRAWINGS

A more complete appreciation will be readily obtained by reference to the following Description of the Example Embodiments and the accompanying drawings.

FIG. 1 shows reversible faradaic electrode arrangement in an MHD cell with applied magnetic field (B) in-plane to produce Lorentz force vector (F) on fluid.

FIG. 2 shows an MHD demonstration setup using N52 magnets.

FIG. 3 shows an I-V curve obtained at a Ag sponge∥AgCl sponge MHD cell in 0.6 M NaCl solution with 1-cm separation, with cell voltage linearly scanned between +1.4 V at 20 mV/s.

FIG. 4 shows the theoretical operation duration to reach capacity limit of MHD cell equipped with porous Ag sponge∥AgCl sponge electrodes at 50% porosity and 50% utilization for different electrode thicknesses.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted to not obscure the present disclosure with unnecessary detail.

Disclosed herein is magnetohydrodynamic pumping of salt water whereby current in an electrochemical cell is supported by reversible faradaic reactions at electrodes that store/release either sodium cations or chloride anions. The defining feature of this technological approach that separates it from conventional MHD pumping of salt water is its use of battery-like reversible faradaic reactions as opposed to electrolysis reactions used in traditional MHD pumping electrodes. Reversible faradaic reactions are employed because of their low-voltage operation compared to electrolysis. This electroreaction control benefits MHD pumping efficiency by lowering operation voltage and eliminates formation of gas products. Additionally, electrolysis-free reactions avoid changes in solution pH that can lead to mineral scale deposits on electrodes and thereby reduce efficiency.

The disclosed apparatus has a flow cell, a first electrode, a second electrode, and a magnetic field generator. A shortest path or approximately shortest path line drawn from the first electrode to the second electrode is define as the “electrode direction”. The flow cell has a first port and a second port allowing for flow of an aqueous salt solution in a between the first and second ports in either direction. The direction between the ports is defined as the “flow direction” and is orthogonal to the electrode direction. Two directions are orthogonal if they are perpendicular, approximately perpendicular, or form an angle that is within 5°, 10°, or 20° of perpendicular. The magnetic field generator generates a magnetic field in a magnetic direction that is orthogonal to the flow direction and orthogonal to the electrode direction. The electrodes may be charge storage electrodes, including those described herein. The magnetic field generator may be any permanent magnet, electromagnet, or other known types of such generators.

In one embodiment, porous Ag “sponge” electrodes are used to support high Faradaic currents in salt water. Silver sponges are prepared as described in U.S. Pat. No. 12,009,501. Briefly, 2 g of silver (I) oxide (Ag₂O) powder is dry-mixed with 1 g of sodium chloride. After achieving a homogeneous mixture, 1 mL of 1 M potassium hydroxide (KOH) is mixed with the dry powder to form a viscous paste that can be molded into the desired electrode dimensions. The molded electrodes are demolded and dried in air at 70-120° C., then baked in air at 700° C. reducing Ag₂O to Ag metal and producing Ag/NaCl composites. Ag/NaCl composites are soaked in water to dissolve NaCl, leaving behind a porous Ag monolith electrode. One porous Ag electrode is soaked in sodium hypochlorite (NaClO) solution to convert Ag sponge surface into a pre-chloridated AgCl@Ag sponge.

The degree of chemical chloridation was investigated for sponge samples soaked in 15 wt. % NaClO solution at either 25 or 60° C. between 30 min and 4 h. Based on the mass change before and after chloridation, up to 54 mol % of the Ag sponge converts after 4 h at 60° C., corresponding to a theoretical reduction capacity of 135 mAh g⁻¹. The actual electrochemical reduction capacities of AgCl@Ag sponges measured are close to theoretical values. This chemical approach to making AgCl@Ag sponges is favorable for its simplicity and scalability.

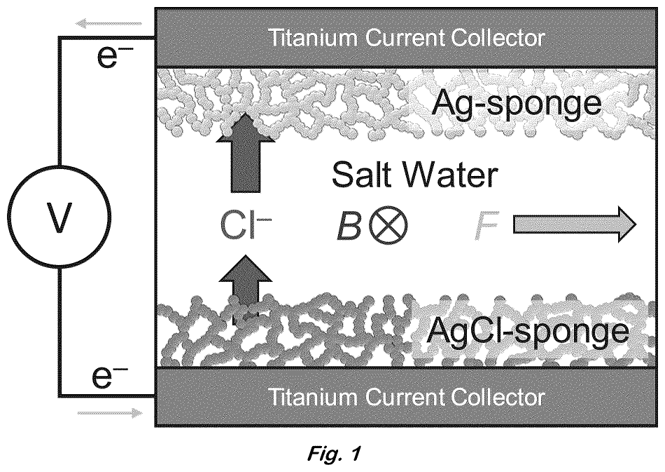

The Ag sponge∥AgCl@Ag sponge MHD cell is constructed by attaching Ag-sponge and AgCl@Ag-sponge to separate titanium current collectors using colloidal silver paste or conductive silver epoxy. The Ag-sponge and AgCl@Ag-sponge electrodes are fixed inside a MHD pump housing that allows separation between manipulated fluid and external circuitry. Electrodes are positioned oppositely parallel to each other with a gap in between for fluid flow. A magnetic field is applied across the electrode gap such that the magnetic field is orthogonal to the direction of desired flow and applied electric field. The MHD pump is activated in salt water by applying a voltage across the Ag-sponge anode and AgCl@Ag-sponge cathode. Chlorine anions are absorbed by the Ag-sponge anode and released by the AgCl@Ag-sponge cathode (FIG. 1) by the following reversible conversion reactions:

Ag-sponge anode: Ag₍ₛ₎+Cl⁻_{(aq)}≈AgCl₍ₛ₎+e⁻

AgCl@Ag-sponge cathode: AgCl₍ₛ₎+e⁻=Ag₍ₛ₎+Cl⁻_{(aq)}

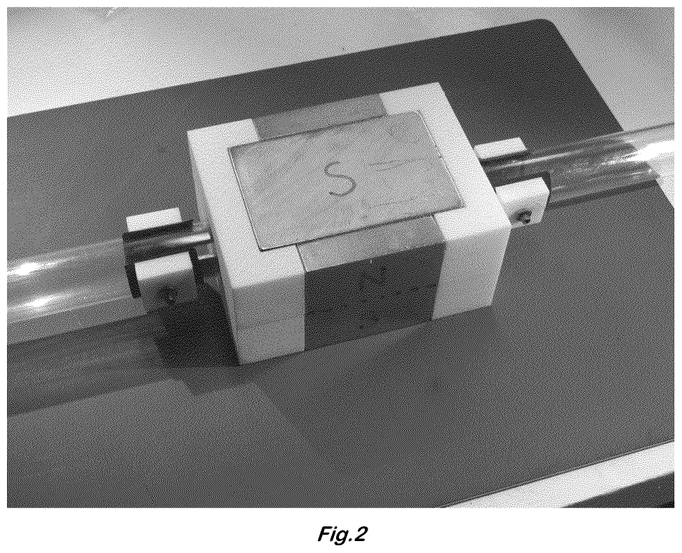

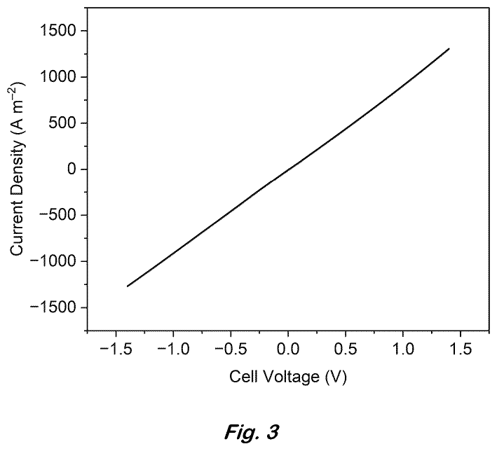

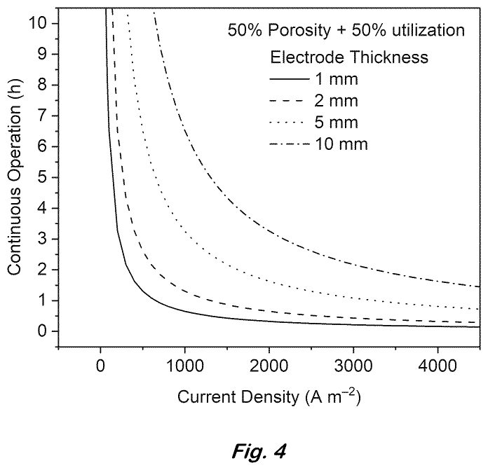

The ionic current generated between anode and cathode under perpendicularly applied magnetic field produces a Lorentz force orthogonal to the applied current and magnetic field (see test cell in FIG. 2), resulting in fluid flow. The current density produced, and thus Lorentz force, linearly depends on the applied potential, with the example Ag-sponge electrodes achieving 1000 A/m² at 1.0 V (FIG. 3). Due to the overvoltage for electrolysis, that is the energy penalty above its thermodynamic minimum, cell voltage can increase beyond 1.23 V; in practice, voltages >2.5 V are commonly required to achieve sufficient current density in electrolysis cells (Liu et al., Water electrolysis using plate electrodes in an electrode-paralleled non-uniform magnetic field. Int. J. Hydrogen Energy 2019, 46, 3329). When ion-capacity limits at the Ag electrodes are reached, polarity of the electrodes and the magnetic field is reversed to allow continuous fluid flow in the same direction. The theoretical duration of continuous current before reaching capacity limits depends on the applied current density and electrode size (FIG. 4).

Other reversible faradaic materials could be used that store/release ions present in salt water and do so at cell voltages that avoid electrolysis of water. These electrode materials include manganese oxide (MnO₂), bismuth oxychloride (BiOCl), Prussian blue and Prussian blue analogs (NiHCF, MnHCF, etc.), and any other electrochemically reversible intercalation or conversion compounds.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

1. An apparatus comprising:
a flow cell having a first port and a second port allowing for flow of an aqueous salt solution in a flow direction from the first port to the second port or from the second port to the first port;
a first electrode positioned to be in contact with the aqueous salt solution;
a second electrode positioned to be in contact with the aqueous salt solution and in an electrode direction from the first electrode that is orthogonal to the flow direction; and
a magnetic field generator that generates a magnetic field in a magnetic direction that is orthogonal to the flow direction and orthogonal to the electrode direction.

2. The apparatus of claim 1, wherein the first electrode, or the second electrode, or both are charge-storage electrodes.

3. The apparatus of claim 1, wherein the first electrode, or the second electrode, or both are capable of electrosorbing and releasing anions.

4. The apparatus of claim 1, wherein the first electrode, or the second electrode, or both are capable of electrosorbing and releasing cations.

5. The apparatus of claim 1;
wherein the first electrode comprises silver; and
wherein the second electrode comprises silver and silver chloride.

6. The apparatus of claim 1, wherein the first electrode or the storage electrode comprises MnO₂, BiOCl, NiHCF, MnHCF, or a Prussian blue analog.

7. The apparatus of claim 1, wherein the magnetic field generator comprises one or more permanent magnets or electromagnets.

8. A method comprising:
providing the apparatus of claim 1;
providing a supply of the aqueous salt solution coupled to the first port or the second port;
filling the flow cell from the supply of the aqueous salt solution; and
applying a voltage between the first electrode and the second electrode sufficient to cause the aqueous salt solution to flow from the supply and through the flow cell at a flow rate while the magnetic field is applied.

9. The method of claim 8, further comprising:
reversing the polarity of the voltage when the flow rate reduces to less than a threshold rate.
